(19) United States
(12) Patent Application Publication
(10) Pub. No.: US 2025/0272357 A1
(43) Pub. Date: Aug. 28, 2025

(54) LEARNING APPARATUS

(71) Applicant: NEC Corporation, Tokyo (JP)

(72) Inventor: Takehiko MIZOGUCHI, Tokyo (JP)

(73) Assignee: NEC Corporation, Tokyo (JP)

(21) Appl. No.: 19/051,340

(22) Filed: Feb. 12, 2025

(30) Foreign Application Priority Data
Feb. 26, 2024 (JP) 2024-026667

(51) Int. Cl. G06F 18/213; G06N 20/00

(52) U.S. Cl. CPC G06F 18/213; G06N 20/00

(57) ABSTRACT

A learning apparatus extracts a feature value from a time-series data set including time-series data on a predetermined observation item by using a machine-learned model, detects a change in an input dimension, which is a change in a number of the observation item included by the time-series data set, adjusts at least one of a weight dimension of the model used when extracting the feature value from the time-series data set and a corresponding input value, in accordance with a result of the detection, and stores information corresponding to a content of the adjustment into a storage device. According to such a configuration, it is possible to respond accurately even if the input dimension changes, and it is possible to support the decision-making of the user appropriately even if the input dimension changes.

### INCORPORATION BY REFERENCE

This application is based upon and claims the benefit of priority from Japanese patent application No. 2024-026667, filed on Feb. 26, 2024, the disclosure of which is incorporated herein in its entirety by reference.

### TECHNICAL FIELD

The present invention relates to a learning apparatus, a learning method, and a recording medium.

### BACKGROUND ART

There is known technology that allows for grasp of the state of a system, such as detection of an anomaly, by making it possible to retrieve time-series data.

For example, Patent Literature 1 describes a time-series data processing apparatus that transforms a time-series data set in which a plurality of time-series data are merged into one, into a feature vector indicating a feature of the time-series data set and makes it possible to retrieve. To be specific, according to Patent Literature 1, the time-series data processing apparatus includes a data transforming unit, a storing unit, and a retrieving unit. For example, the data transforming unit transforms a partial time-series data set obtained by dividing a time-series data set that is a set of a plurality of time-series data by a predetermined time, into a feature vector indicating a feature of the partial time-series data set. Moreover, the storing unit stores a plurality of first partial time-series data sets in association with a plurality of first feature vectors in which the plurality of first partial time-series data sets are transformed by the data transforming unit. Then, the retrieving unit selects at least one first feature vector in which an input second partial time-series data set is similar to a second feature vector transformed by the data transforming unit of the plurality of first feature vectors stored in the storing unit, and outputs the first partial time-series data set corresponding to the selected first feature vector.
Patent Literature 1: WO 2020/049666

In the case of the technique described in Patent Literature 1, it is assumed that the input dimension does not change between at the time of learning and at the time of retrieving. However, the input dimension may change due to addition of a new observation item, deletion of an existing observation item or the like between at the time of learning and at the time of retrieving. As a result, it is necessary to prepare a new model, which requires relearning. Thus, there has been a problem that it is difficult to realize efficient machine learning according to a change in input dimension.

### SUMMARY OF THE INVENTION

Accordingly, one of the objects of the present invention is to provide a learning apparatus, a learning method and a program that can solve the abovementioned problem.

In order to achieve the object, a learning apparatus as an aspect of the present disclosure includes: an extracting unit that extracts a feature value from a time-series data set including time-series data on a predetermined observation item by using a machine-learned model; a detecting unit that detects a change in an input dimension, which is a change in a number of the observation item included by the time-series data set; an adjusting unit that adjusts at least one of a weight dimension of the model used when the extracting unit extracts the feature value from the time-series data set and a corresponding input value, in accordance with a result of the detection by the detecting unit; and a storing unit that stores information corresponding to a content of the adjustment by the adjusting unit into a storage device.

Further, a learning method as another aspect of the present disclosure includes: extracting a feature value from a time-series data set including time-series data on a predetermined observation item by using a machine-learned model; detecting a change in an input dimension, which is a change in a number of the observation item included by the time-series data set; adjusting at least one of a weight dimension of the model used when extracting the feature value from the time-series data set or a corresponding input value in accordance with a result of the detection; and storing information corresponding to a content of the adjustment into a storage device.

Further, a recording medium as another aspect of the present disclosure is a non-transitory computer readable-recording medium is a non-transitory computer-readable recording medium with a program recorded thereon. The program includes instructions for causing an information processing apparatus to: extract a feature value from a time-series data set including time-series data on a predetermined observation item by using a machine-learned model; detect a change in an input dimension, which is a change in a number of the observation items included by the time-series data set; adjust at least one of a weight dimension of the model used when extracting the feature value from the time-series data set or a corresponding input value in accordance with a result of the detection; and store information corresponding to a content of the adjustment into a storage device.

According to the configurations as described above, it is possible to respond to a change in input dimension.

### BRIEF DESCRIPTION OF DRAWINGS

FIG. 1 is a diagram illustrating a problem in allowing for retrieval of time-series data;

FIG. 2 is a block diagram showing an example configuration of a learning apparatus;

FIG. 3 is a diagram showing an example of observation item information;

FIG. 4 is a diagram for describing an example of processing when the input dimension is increased;

FIG. 5 is a diagram for describing an example of processing when the input dimension is reduced;

FIG. 6 is a flowchart showing an example of operation of the learning apparatus;

FIG. 7 is a flowchart showing an example of operation of the learning apparatus;

FIG. 8 is a block diagram showing another example configuration of the learning apparatus;

FIG. 9 is a diagram showing an application example of the learning apparatus;

FIG. 10 is a diagram for describing an example of an effect according to the present disclosure;

FIG. 11 is a diagram showing another application example of the learning apparatus;

FIG. 12 is a diagram showing an example of a hardware configuration of a learning apparatus in a second example embodiment of the present disclosure;

FIG. 13 is a block diagram showing an example configuration of the learning apparatus; and

FIG. 14 is a flowchart showing an example of operation of the learning apparatus.

### EXAMPLE EMBODIMENT

### First Example Embodiment

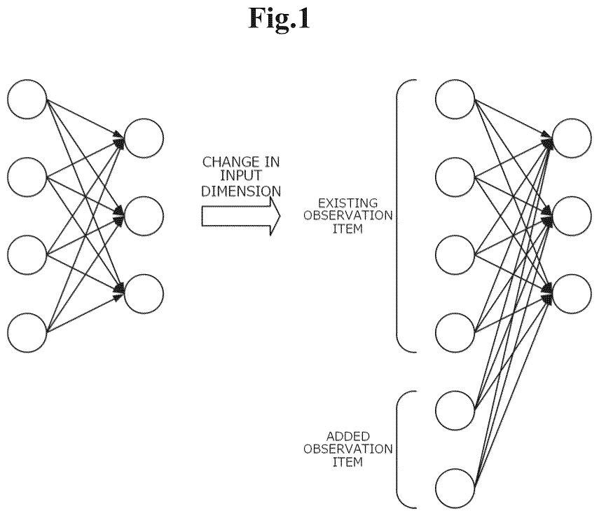

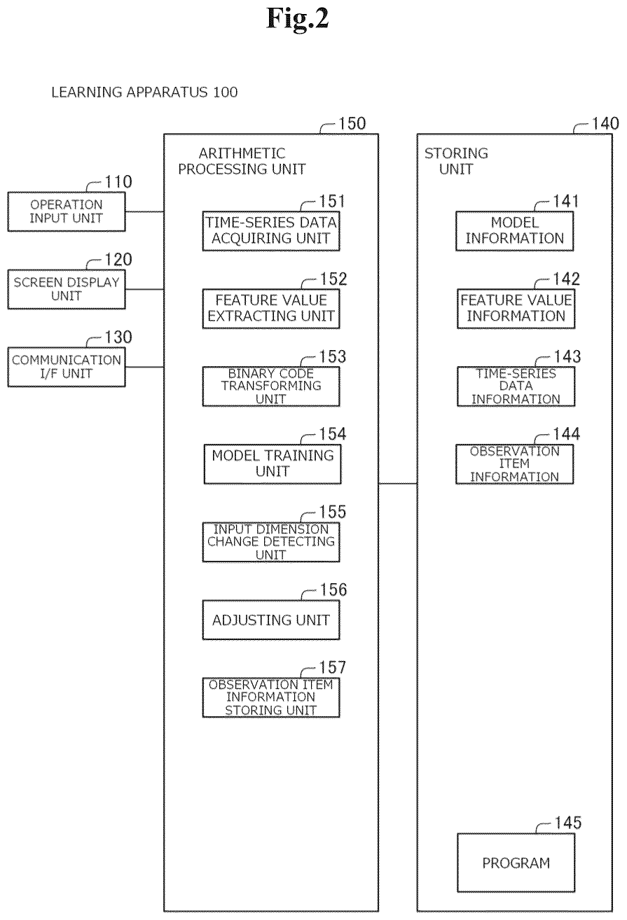

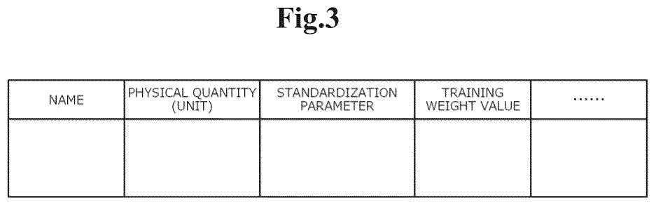

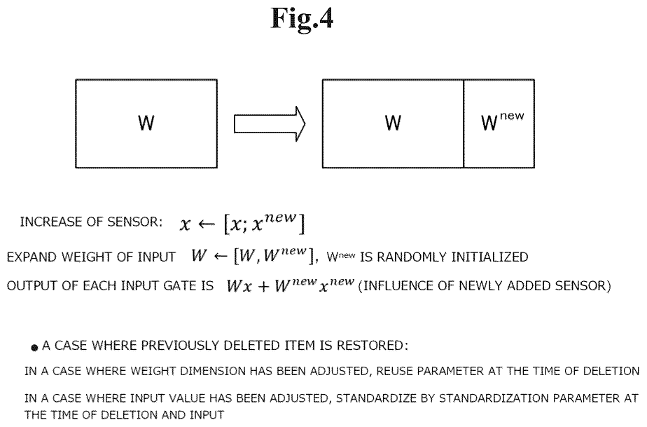

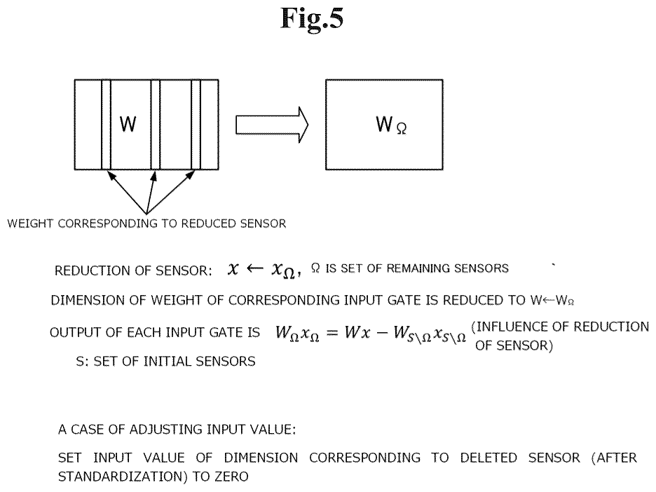

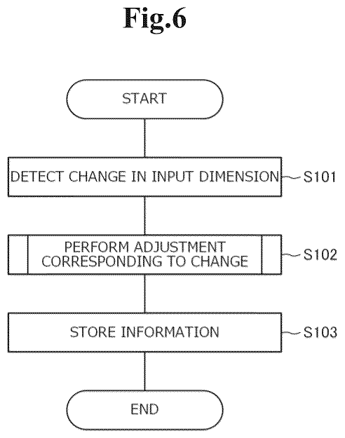

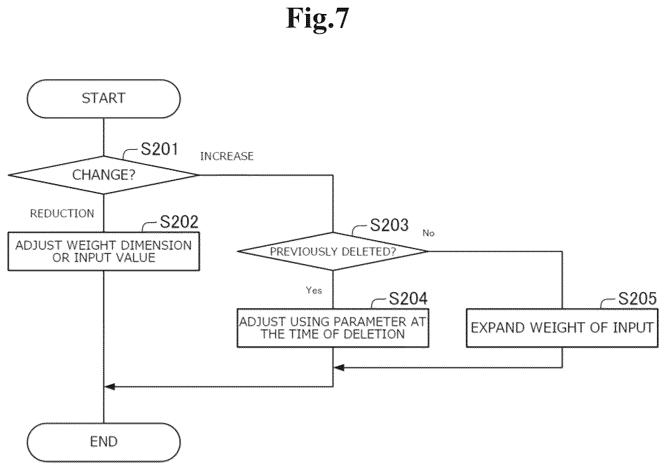

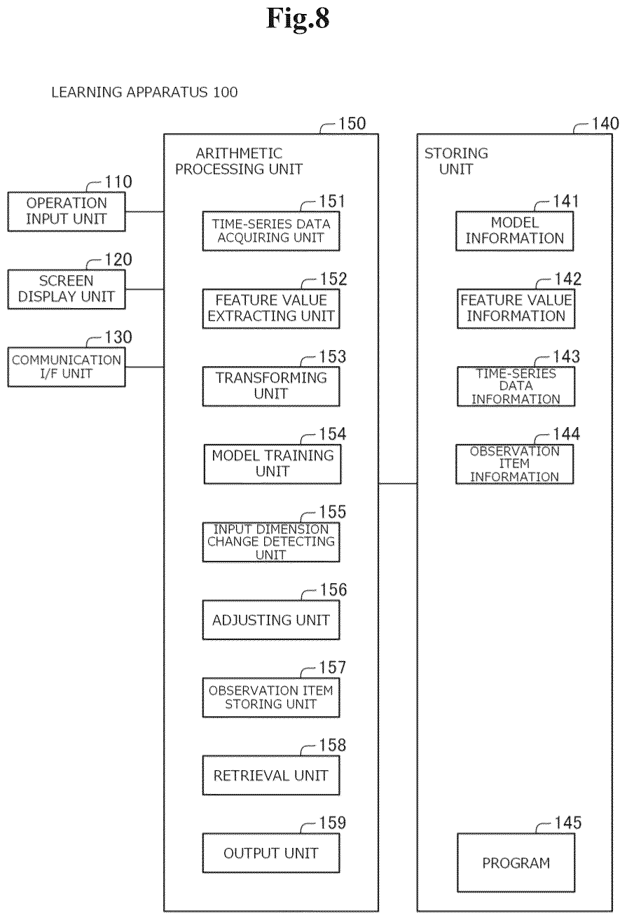

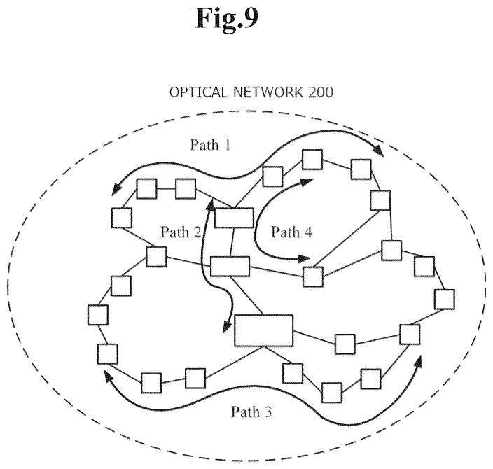

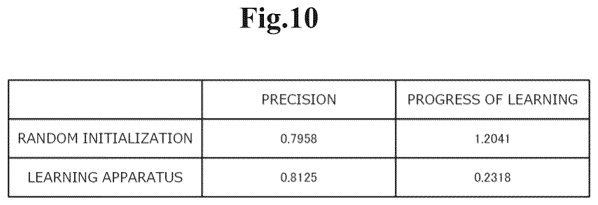

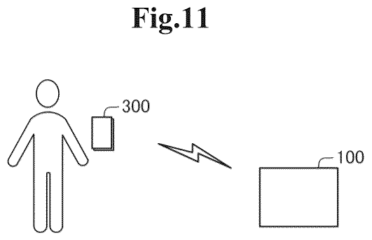

A first example embodiment of the present invention will be described with reference to FIGS. 1 to 11. FIG. 1 is a diagram illustrating a problem in allowing retrieval of time-series data. FIG. 2 is a block diagram showing an example configuration of a learning apparatus 100. FIG. 3 shows an example of information included by observation item information 144. FIG. 4 is a diagram for describing an example of processing when the input dimension is increased. FIG. 5 is a diagram for describing an example of processing when the input dimension is reduced. FIGS. 6 and 7 are flowcharts showing an example of operation of the learning apparatus 100. FIG. 8 is a block diagram showing another example configuration of the learning apparatus. FIG. 9 is a diagram showing an application example of the learning apparatus. FIG. 10 is a diagram for describing an example of an effect according to the present disclosure. FIG. 11 is a diagram showing another application example of the learning apparatus. In the present disclosure, the drawings may be associated with one or a plurality of example embodiments.

In the first example embodiment of the present disclosure, the learning apparatus 100 will be described, which is an information processing apparatus that trains or updates a machine-learned model based on a time-series data set including one or a plurality of time-series data that are time-series observation data. For example, the input dimension may change from the time of training the model due to addition of a new observation item such as increase of sensors or deletion of an existing observation item such as decrease of sensors. In such a case, as shown in FIG. 1, when a new model corresponding to the number of input dimensions after the change is prepared, weights included in the model are randomly initialized, which requires relearning from the beginning.

Therefore, when detecting a change in input dimension such as increase or decrease of sensors, the learning apparatus 100 to be described in the present disclosure changes the weight dimension of a first layer (input gate) in accordance with the detected change. That is to say, the learning apparatus 100 continuously uses a common part by extending or reducing the weights in accordance with the change in input dimension. Consequently, the learning apparatus 100 responds to a change in input dimension without preparing a new model.

When the input dimension is reduced, the learning apparatus 100 may, instead of adjusting the weight dimension, adjust a corresponding input value such as setting the input value to 0. For example, as shown by Formula 1, a value propagating to an intermediate layer has no mathematical difference between the case of deleting the weight (the case of setting to 0) and the case of adjusting the input value to 0 (whichever of weight Wψ and input value xψ may be set to 0). Therefore, the adjustment of the input value may be performed instead of the adjustment of the weight dimension.

$$Wx = [ {W}_{Ω} {W}_{Ψ} ] [ \begin{matrix}{x}_{Ω} \\ {x}_{Ψ}\end{matrix} ] = {W}_{Ω} {x}_{Ω} + {W}_{Ψ} {x}_{Ψ} \qquad [ Formula 1 ]$$

where W corresponds to the weight, and x corresponds to the input value from the observation item.

Further, at the time of performing an adjustment according to a change in input dimension, such as when adjusting the weight or the input value in accordance with reduction of input dimension, the learning apparatus 100 stores information indicating an observation item such as a reduced sensor and information according to the adjustment such as the weight value to be deleted, and the like. Consequently, the learning apparatus 100 can perform an adjustment using a past adjustment result in accordance with a change in input dimension, such as performing an adjustment using past information in a case where a reduced observation item is added again. As a result, the learning apparatus 100 can perform a more efficient adjustment using a past learning result.

In the present disclosure, a change in input dimension refers to a change in the number of time-series data included in a time-series data set due to addition of a new observation item, deletion of an existing observation item, or the like. That is to say, a change in input dimension refers to a change in the number of observation items. For example, the number of time-series data included in a time-series data set changes in accordance with a change in the number of sensors acquiring time-series data or a change in the number of data input as time-series data. That is to say, the input dimension changes. As the change in input dimension, either the increase or the reduction may occur, and the increase and the reduction may occur simultaneously.

Further, in the case of the present disclosure, the observation content of a common observation item shall not change before and after a change in input dimension. That is to say, an observation item other than the added or deleted observation item shall continue to acquire time-series data in the same manner as before the addition or deletion of the observation item. By changing the weight dimension in accordance with the change in input dimension, the learning apparatus 100 can maintain a relation between common inputs before and after the change, while allowing an effect of the change in observation items to be considered.

Further, the learning apparatus 100 described in the present disclosure can train a model by using, for example, a supervised metric learning method as described in Patent Literature 1. For example, the learning apparatus 100 extracts an anchor sample at random from a feature value group including a plurality of feature values extracted from a time-series data set, and also extracts a positive sample with the same label as the anchor sample assigned and a negative sample with a different label from the anchor sample assigned. Then, the learning apparatus 100 trains or updates the model by updating weight parameters so as to narrow the metric between the anchor sample and the positive sample and widen the metric between the anchor sample and the negative sample in the feature space. In addition, the learning apparatus 100 may perform learning using a method other than that illustrated above.

FIG. 2 shows an example configuration of the learning apparatus 100. Referring to FIG. 2, the learning apparatus 100 includes, as main components, an operation input unit 110, a screen display unit 120, a communication interface unit 130, a storing unit 140, and an arithmetic processing unit 150, for example.

FIG. 2 illustrates a case of realizing a function as the learning apparatus 100 using one information processing apparatus. However, at least part of the function as the learning apparatus 100 may be realized using a plurality of information processing apparatuses, such as being realized on the cloud, for example. Moreover, the learning apparatus 100 may not include part of the above-illustrated configuration, such as not having the operation input unit 110 or the screen display unit 120, and may have a configuration other than the above-illustrated configuration.

The operation input unit 110 is configured with an operation input device such as a keyboard and a mouse. The operation input unit 110 detects an operation by an operator who operates the learning apparatus 100, and outputs it to the arithmetic processing unit 150.

The screen display unit 120 is configured with a screen display device such as a liquid crystal display and an organic EL (electro-luminescence). The screen display unit 120 can display on a screen a variety of information and the like stored in the storing unit 140 in accordance with an instruction from the arithmetic processing unit 150.

The communication interface unit 130 is configured with a data communication circuit and so forth. The communication interface unit 130 performs data communication with various sensors and other external devices connected via communication lines.

The storing unit 140 is a storage device such as a hard disk and memory. The storing unit 140 stores processing information and a program 145 necessary for a variety of processing by the arithmetic processing unit 150. The program 145 is read and executed by the arithmetic processing unit 150 to realize various processing units. The program 145 is loaded in advance from an external device or a recording medium via a data input/output function such as the communication interface unit 130 and stored in the storing unit 140. Main information stored in the storing unit 140 includes, for example, model information 141, feature value information 142, time-series data information 143, and observation item information 144.

The model information 141 includes information on a model that extracts and outputs a feature value preserving a local metric relation for an input of a time-series segment obtained by dividing a time-series data set. For example, the model information 141 may include weight parameters or the like included in the trained model as described above. For example, the model included in the model information 141 is trained in advance using time-series segments for learning inside or outside the learning apparatus 100 and is stored in the storing unit 140. Moreover, the model information 141 is updated by training by a model training unit 154, which will be described later. Moreover, the number of dimensions of the weight parameters included in the model information 141 is adjusted by the adjusting unit 156, which will be described later.

The feature value information 142 includes information corresponding to a feature value to be extracted from a time-series segment. For example, the feature value information 142 includes a binary code obtained by transforming a feature value by any method. In the feature value information 142, the binary code may be associated with a label to be classified, and so forth. For example, the binary code included in the feature value information 142 is acquired by a method in which a binary code transforming unit 153 transforms a feature value extracted by a feature value extracting unit 152, and is stored in the storing unit 140.

In addition, the information included in the feature value information 142 can be used at the time of, for example, performing a retrieval process, which will be described later. For example, the result of the retrieve process may be used to determine the presence or absence of an anomaly and to determine a label to belong. The result of the retrieve process may be used for purposes other than those illustrated above.

The time-series data information 143 includes a time-series data set including one or a plurality of time-series data. Here, the time-series data may be, for example, data in which numerical data such as observation data measured by a sensor at predetermined periods are arranged in order of measurement time. The time-series data may be time-series information input using the operation input unit 110 or the like, such as information indicating the time and content of meal, body temperature, and medication content. The time-series data information 143 is updated in accordance with by acquisition of time-series data from the sensor and other devices by a time-series data acquiring unit 151 to be described later.

The observation item information 144 includes information corresponding to the status of an observation item and a past training result, for example, information on the observation item such as the sensor, a weight value and an input value adjusted in accordance with a change in observation item, and so forth. The observation item information 144 is updated, for example, when an observation item storing unit 157 stores information indicating the content of the adjustment in accordance with the adjustment by the adjusting unit 156. At least part of the information included in the observation item information 144 may be acquired in advance by receiving it from an external device via the communication interface unit 130 and be stored in the storing unit 140.

FIG. 3 shows an example of the observation item information 144. Referring to FIG. 3, in the observation item information 144, for example, name, physical quantity (unit), standardization parameter, training weight value and so forth are associated. Here, name is information indicating an object being observed, such as the name of an observation item such as a sensor and any other identifier. Physical quantity (unit) is information indicating the unit of measurement, such as g, kg, and db. Standardization parameter indicates a value before an adjustment in an input value adjusted to 0 in accordance with a change in input dimension. Training weight value indicates a weight value deleted in accordance with a change in input dimension. In addition, an item other than those illustrated above may be associated with the observation item information 144.

The arithmetic processing unit 150 includes an arithmetic logic unit such as a CPU (Central Processing Unit) and peripheral circuits thereof. The arithmetic processing unit 150 reads the program 145 from the storing unit 140 and executes it, thereby making the above hardware and the program 145 to cooperate and realizing various processing units. Main processing units realized by the arithmetic processing unit 150 include, for example, a time-series data acquiring unit 151, a feature value extracting unit 152, a binary code transforming unit 153, a model training unit 154, an input dimension change detecting unit 155, an adjusting unit 156, and an observation item information storing unit 157.

The arithmetic processing unit 150 may have a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination of these, instead of the abovementioned CPU.

The time-series data acquiring unit 151 acquires a time-series data set by acquiring time-series data from various sensors and other devices. The time-series data acquiring unit 151 may receive input of information using the operation input unit 110 or the like as at least part of the time-series data included in the time-series data set. Moreover, the time-series data acquiring unit 151 stores the acquired time-series data set as the time-series data information 143 into the storing unit 140.

The feature value extracting unit 152 inputs a time-series segment into the model stored as the model information 141, thereby extracting a feature value from the time-series segment. For example, the feature value extracting unit 152 divides a time-series data set acquired by the time-series data acquiring unit 151 into a plurality of time-series segments using a time window of a certain period. Then, the feature value extracting unit 152 inputs each of the division time-series segments into the trained model, thereby extracting a feature value. In addition, the feature value extracting unit 152 may perform the division into time-series segments using any method. For example, the size of the time window may be set to any size. Moreover, the feature value extracting unit 152 may divide a time-series data into a plurality of time-series segments so as to overlap for any period, or may divide a time-series data into a plurality of time-series segments so as to avoid overlapping the time-series segments.

The binary code transforming unit 153 transforms the feature value extracted by the feature value extracting unit 152 into a binary code that is information corresponding to the feature value. In the present disclosure, there is no particular limitation on a method for transforming into a binary code. The binary code transforming unit 153 may transform the feature value extracted by the feature value extracting unit 152 into a binary code using any method. Moreover, the binary code transforming unit 153 can store the binary code obtained by transformation as the feature value information 142 into the storing unit 140.

In addition, the feature value extracting unit 152 or the binary code transforming unit 153 may assign a label to be a classification target to the feature value or the binary code using any method. For example, the feature value extracting unit 152 or the binary code transforming unit 153 may assign, to the feature value and the like, a label determined in accordance with the Euclidean distance between the time-series segment from which the feature value is extracted and the time-series segment to be compared. Information about the label may be acquired in accordance with an operator's operation or the like on the operation input unit 110.

The model training unit 154 performs training based on the feature value extracted by the feature value extracting unit 152, thereby updating the model stored as the model information 141.

For example, the model training unit 154 trains the model using a supervised metric learning method as described in Patent Literature 1. The model training unit 154 can train the model so that a metric learning loss is minimized. As an example, the model training unit 154 extracts an anchor sample at random from a feature value group including the plurality of feature values extracted by the feature value extracting unit 152, and also extracts a positive sample with the same label as the anchor sample assigned and a negative sample with a different label from the anchor sample assigned. At this time, the model training unit 154 extracts the anchor sample, the positive sample, and the negative sample from feature values in which a data characteristic of the extraction source is the same among the feature values included by the feature value group. After that, the model training unit 154 compares the extracted samples, thereby updating the model. For example, the model training unit 154 can update the model by updating a weight parameter so as to narrow the metric between the anchor sample and the positive sample and widen the metric between the anchor sample and the negative sample in the feature space.

A label corresponding to each feature value may be assigned by the feature value extracting unit 152 or the binary code transforming unit 153, or may be assigned by the model training unit 154. For example, the model training unit 154 may assign a label to each feature value using the same method as the feature value extracting unit 152 or the binary code transforming unit 153.

Further, a loss function used by the model training unit 154 in training may be any function as long as the loss function preserves a local similarity relation between data in the input space. For example, the loss function may be not only a Triplet loss, but also a Pairwise loss or a Contrastive loss. Moreover, a model to be trained by the model training unit 154 may be any model that can handle time-series data. For example, the model may be any of 1D-CNN (1 Dimensional-Convolutional Neural Network), GRU (Gated Recurrent Unit), LSTM (Long Short-Term Memory), Transformer, and the like.

The input dimension change detecting unit 155 detects a change in input dimension. The input dimension change detecting unit 155 may use any means to detect a change in input dimension according to addition or deletion of an observation item. Moreover, the input dimension change detecting unit 155 can acquire information on the added or deleted observation item.

For example, the input dimension change detecting unit 155 can detect a change in input dimension in accordance with receiving information indicating a change in observation item such as increase or decrease of the number of sensors from management software or the like that manages sensors performing observation. Moreover, the input dimension change detecting unit 155 may detect a change in input dimension in accordance with monitoring, for example, the number of time-series data acquired by the time-series data acquiring unit 151. The input dimension change detecting unit 155 may detect a change in input dimension by a method other than those illustrated above, such as detecting a change in input dimension in accordance with, for example, acquiring information on a new observation item via the operation input unit 110 or the like.

The adjusting unit 156 performs a predetermined adjustment such as an adjustment of the weight dimension of a first layer of a model to be trained in accordance with the result of detection by the input dimension change detecting unit 155. In other words, the adjusting unit 156 increases or reduces the number of weight parameters of the first layer included in the model information 141 in accordance with the result of detection by the input dimension change detecting unit 155. For example, the adjusting unit 156 can expand the weight dimension in accordance with detection of increase of input dimension, or reduce the weight dimension in accordance with detection of reduction of input dimension. Moreover, the adjusting unit 156 may adjust an input value after standardization to 0, instead of reducing the weight dimension of the first layer in accordance with detection of reduction of input dimension.

For example, referring to FIG. 4, the adjusting unit 156 refers to the observation item information 144 in accordance with detection of increase of input dimension by the input dimension change detecting unit 155. Consequently, the adjusting unit 156 confirms whether or not the increased observation item has been deleted previously. Then, in a case where it is determined that a new observation item is added according to the observation item information 144, the adjusting unit 156 expands the weight dimension of the first layer. For example, the adjusting unit 156 may add a weight parameter corresponding to the number of changes in input dimension such as the number of increased sensors at each node in the first layer. Here, the value of a weight parameter W_{new} to be added is, for example, a randomly initialized value. Consequently, the output of each input gate becomes Wx+W^{new}x^{new}, influenced by increase of input dimension, such as an influence of a newly added sensor. Note that W corresponds to the weight parameter and x corresponds to the time-series data acquired from the sensor in the illustrated formula. Moreover, W^{new} corresponds to an additional weight parameter that is randomly initialized, and it corresponds to time-series data acquired by a sensor with increased x^{new}, or the like. Moreover, the value of the weight parameter W^{new} may be arbitrarily determined from domain knowledge.

Further, in a case where it is determined that an increased observation item such as a sensor is an observation item having been deleted previously in accordance with the observation item information 144, the adjusting unit 156 can perform an adjustment according to past information included in the observation item information 144. For example, in a case where the weight dimension has been reduced in accordance with detection of reduction of input dimension, the adjusting unit 156 refers to the observation item information 144 to identify a deleted weight value. Then, the adjusting unit 156 can use the identified weight value as the value of the weight parameter W^{new} to be added. Moreover, in a case where the input value has been adjusted in accordance with detection of reduction of input dimension, the adjusting unit 156 identifies an input value before the adjustment with reference to the observation item information 144. Then, the adjusting unit 156 can perform standardization or the like using the identified input value to make a new input value.

Further, referring to FIG. 5, the adjusting unit 156 reduces the weight dimension of the first layer in accordance with detection of reduction of input dimension by the input dimension change detecting unit 155, such as decrease of sensors. For example, the adjusting unit 156 reduces the number of weight parameters in a node corresponding to an input such as a reduced sensor. Consequently, the output of each input gate becomes W_{Ω}x_{Ω}=Wx−W(_{s-Ω})x(_{s-Ω}), influenced by reduction of input dimension, such as an influence of the reduced sensor. In addition, the adjusting unit 156 may identify the corresponding node using any means such as storing each sensor and the corresponding node in association. In other words, the adjusting unit 156 may perform the above-described identification in accordance with the observation item information 144 and the like. The adjusting unit 156 may adjust the weight parameter at each node of the first layer. Moreover, in the illustrated formula, s corresponds to the set of sensors before the reduction, and Ω corresponds to the set of remaining sensors.

Further, as described above, the adjusting unit 156 can adjust an input value after standardization to 0, instead of reducing the weight dimension of the first layer in accordance with detection of reduction of input dimension. It may be arbitrarily determined whether the adjusting unit 156 performs the adjustment of the weight dimension or the adjustment of the input value.

For example, as illustrated above, the adjusting unit 156 adjusts the weight dimension of the first layer of a model to be trained in accordance with the result of detection by the input dimension change detecting unit 155. In addition, the adjusting unit 156 may adjust the weight dimension of the first layer by a method other than those illustrated above in accordance with the result of detection by the input dimension change detecting unit 155. For example, the adjusting unit 156 may adjust the weight dimension by a method corresponding to the type of a model to be trained, such as LSTM.

The observation item information storing unit 157 stores information indicating the content of adjustment and the like as the observation item information 144 into the storing unit 140 in accordance with the adjustment by the adjusting unit 156. For example, when the adjusting unit 156 performs an adjustment in accordance with detection of reduction of input dimension, the observation item information storing unit 157 stores information corresponding to the content of the adjustment as the observation item information 144 into the storing unit 140. As an example, the observation item information storing unit 157 stores, into the storing unit 140, each information included in the observation item information 144, such as information on an observation item corresponding to the adjustment and a weight value and an input value before the adjustment to 0, as information corresponding to the content of the adjustment. In addition, the observation item information storing unit 157 may store information corresponding to the content of the adjustment by the adjusting unit 156 as the observation item information 144 into the storing unit 140 at a timing other than those illustrated above, such as when the adjusting unit 156 performs an adjustment in accordance with detection of increase of input dimension.

The above is an example configuration of the learning apparatus 100. Subsequently, an example of operation of the learning apparatus 100 when the input dimension changes will be described with reference to FIGS. 6 and 7.

FIG. 5 shows an example of operation of the learning apparatus 100. Referring to FIG. 5, the input dimension change detecting unit 155 detects a change in input dimension (step S101). The input dimension change detecting unit 155 may use any means to detect a change in input dimension according to addition or deletion of an observation item, and so forth.

The adjusting unit 156 performs an adjustment corresponding to the change in dimension in accordance with the detection by the input dimension change detecting unit 155 (step S102). For example, the adjusting unit 156 can adjust at least one of a weight and an input value in accordance with the detection by the input dimension change detecting unit 155.

The observation item information storing unit 157 stores information indicating an adjustment content and the like as the observation item information 144 into the storing unit 140 in accordance with the adjustment by the adjusting unit 156 (step S103).

The above is an example of operation of the learning apparatus 100. Subsequently, the process at step S102 will be described in more detail with reference to FIG. 7.

Referring to FIG. 7, in accordance with the detection of input dimension reduction by the input dimension change detecting unit 155, such as reduction of a sensor (step S201, reduction), the adjusting unit 156 reduces the weight dimension of the first layer, or adjusts the input value after standardization to 0 (step S202). It may be arbitrarily determined whether the adjusting unit 156 performs the adjustment of the weight or the adjustment of the input value.

Further, in accordance with the detection of input dimension increase by the input dimension change detecting unit 155, such as increase of a sensor (step S201, increase), the adjusting unit 156 confirms whether or not the increased observation item is one having been deleted previously with reference to the observation item information 144 (step S203).

In a case where it is determined that the observation item is the one having been deleted previously from the observation item information 144 (step S203, Yes), the adjusting unit 156 performs an adjustment corresponding to past information included in the observation item information 144 (step S204). On the other hand, in a case where a new observation item is added (step S203, No), the adjusting unit 156 expands the weight dimension of the first layer by, for example, adding a randomly initialized weight parameter (step S205).

The above is a more detailed operation example at step S102. In addition, FIG. 7 shows an example of the process at step S102, and the operation of the adjusting unit 156 at step S102 is not limited to the case illustrated in FIG. 7. For example, regarding a change in input dimension, not only one of increase or reduction, but also increase and reduction may occur simultaneously. In this case, the adjusting unit 156 can simultaneously perform an adjustment corresponding to increase of input dimension and an adjustment corresponding to reduction of input dimension.

Thus, the learning apparatus 100 includes the input dimension change detecting unit 155 and the adjusting unit 156. According to such a configuration, the adjusting unit 156 can perform an adjustment of the weight dimension of the first layer of a model to be trained in accordance with the result of detection by the input dimension change detecting unit 155. As a result, the learning apparatus 100 can respond to a change in input dimension while continuing to use a common part by performing an adjustment corresponding to the change in input dimension.

Further, by referring to the observation item information 144, the learning apparatus 100 can perform an adjustment using past information, for example, when it is determined that an observation item having been previously deleted is restored. As a result, the learning apparatus 100 can perform a more efficient adjustment using a past learning result.

In addition, the configuration of the learning apparatus 100 is not limited to the configuration illustrated with reference to FIG. 2. For example, the learning apparatus 100 may be configured with part of the configuration illustrated in FIG. 2, such as not having the binary code transforming unit 153. Moreover, FIG. 8 shows another example configuration of the learning apparatus 100. Referring to FIG. 8, for example, the arithmetic processing unit 150 can realize a retrieval unit 158 and an output unit 159 in addition to the configuration illustrated in FIG. 2 by reading the program 145 from the storing unit 140 and executing it.

The retrieval unit 158 performs a retrieval process based on a feature value extracted from a time-series segment to be a retrieval target.

For example, when the time-series data acquiring unit 151 acquires a time-series data set to be a retrieval target, the feature value extracting unit 152 divides the retrieval target time-series data set into a plurality of time-series segments, thereby extracting a feature value. Moreover, the binary code transforming unit 153 transforms the feature value extracted by the feature value extracting unit 152 into a binary code that is information corresponding to the feature value. The retrieval unit 158 acquires the binary code obtained by transformation in the above manner. Then, the retrieval unit 158 retrieves a binary code similar to the acquired binary code from the feature value information 142. For example, the retrieval unit 158 calculates the metric between the acquired binary code and each of the binary codes included in the feature value information 142, respectively. Then, the retrieval unit 158 acquires a binary code satisfying any condition, such as a binary code in which the calculated metric is minimized among the binary codes included in the feature value information 142, as a binary code similar to the acquired binary code.

Further, the retrieval unit 158 can perform a variety of processing according to the result of the retrieval. For example, the retrieval unit 158 can predict a label of the retrieval target time-series segment by identifying a label associated with the binary code acquired by the retrieval. Moreover, the retrieval unit 158 may detect an anomaly in accordance with the result of the retrieval. For example, a binary code corresponding to time-series data at the time of anomaly is stored in advance in the feature value information 142. The retrieval unit 158 calculates an anomaly score corresponding to the metric between a binary code to be a retrieval target and a retrieved binary code. Then, the retrieval unit 158 can detect an anomaly based on the calculated anomaly score. For example, the retrieval unit 158 may detect an anomaly in accordance with the result of comparison between the calculated anomaly score and a predetermined threshold value. The retrieval unit 158 may execute a process corresponding to the result of the retrieval other than those illustrated above.

The output unit 159 outputs the result of the retrieval by the retrieval unit 158, and so forth. For example, the output unit 159 may output the predicted label, the anomaly score, and so forth. The output unit 159 can display the retrieval result and so forth on the screen display unit 120, or transmit the retrieval result and so forth to an external device via the communication interface unit 130. In addition, the output unit 159 may be configured to output information stored in the storing unit 140, such as the feature value information 142, in addition to the retrieval result and so forth.

Further, the learning apparatus 100 described in the present disclosure can be applied to various situations where the input dimension may change. For example, the learning apparatus 100 can be applied to the field of optical communication, such as estimation of the optical signal to noise ratio (OSNR) in accordance with the intensity of an optical signal acquired by an optical transponder and measurement of the degree of anomaly in accordance with the intensity of an optical signal acquired by a plurality of optical performances in an optical network 200 shown in FIG. 9. For example, in a large-scale network such as the optical network 200, a plurality of paths exist, but the number of paths present in the optical network 200 may change during operation. At this time, the number of optical performance monitors, which is the number of sensors, changes in conjunction with the number of passes, so that the input dimension changes in accordance with the change of the number of passes. Using the learning apparatus 100 described in the present disclosure, it is possible to adapt without any problems even in a case where the input dimension changes in the middle of the use as illustrated above.

FIG. 10 shows an example of an effect by the learning apparatus 100 in a case where new learning is performed for a predetermined period after the number of optical performance monitors measuring the intensity of optical signals is increased in the middle (that is, a case where the input dimension is increased). For example, FIG. 10 shows an example of comparison between a case where a new model is prepared in accordance with a change in input dimension and each weight parameter is randomly initialized and then trained, and a case where continuous learning is performed using the learning apparatus 100. Here, in FIG. 10, the precision is a value such as Precision@1, which is a value indicating to what extent binary coding that captures a feature is realized. The precision indicates that the larger the value, the more accurate and closer the transformation is. Moreover, the degree of learning progress is a value such as a Triplet loss, which indicates how advanced the learning is. The degree of learning progress indicates that the smaller the value, the higher the learning progress. Referring to FIG. 10, it can be seen that in a case where the learning apparatus 100 is used, the transformation is more accurate and closer and the learning is also more advanced than in a case where a new model is prepared.

Further, as shown in FIG. 11, the learning apparatus 100 may be used in a healthcare setting, and the like. For example, the learning apparatus 100 can acquire time-series data such as biological data by using input using one or a plurality of biosensors 300 and the operation input unit 110 owned by a patient and any other user. In the case of such a configuration, there is a feat that the input dimension may change in the middle of the use, for example, the type of acquired biometric data such as heart rate or blood pressure increases due to addition of a biometric sensor 300 such as a sphygmomanometer or a heart rate monitor. Moreover, the type of acquired biometric data may increase or decrease during sleep, work, meal, exercise, and the like. Using the learning apparatus 100 described in the present disclosure, it is possible to adapt without any problems even in a case where the input dimension changes in the middle of the use as illustrated above. That is to say, by using the learning apparatus 100 described in the present disclosure, even if the input dimension changes in the middle of the use, anomaly detection and the like can be performed without any problems, and decision-making by the user such as the patient can be supported. Moreover, by realizing a function of sharing with others, such as transmitting the detection result to an external device, it is possible to support decision-making by enabling appropriate intervention by family members and doctors in charge.

The learning apparatus 100 can be applied to various situations as described above. For example, the learning apparatus 100 may be applied to situations other than the examples described above, such as a plant.

### Second Example Embodiment

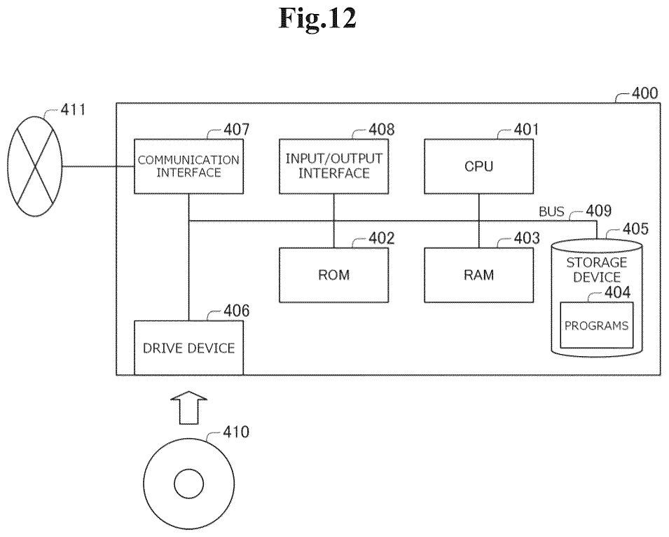

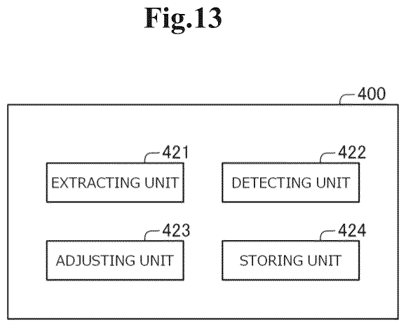

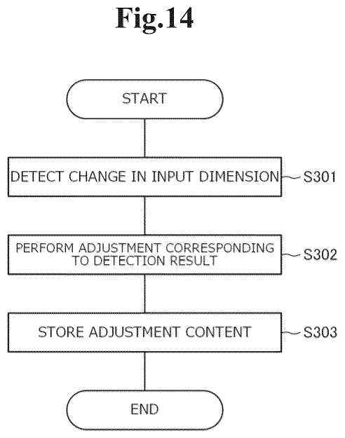

Next, a second example embodiment of the present disclosure will be described with reference to FIGS. 12 to 14. FIG. 12 is a diagram showing an example of a hardware configuration of a learning apparatus 400. FIG. 13 is a block diagram showing an example configuration of the learning apparatus 400. FIG. 14 is a flowchart showing an example of operation of the learning apparatus 400.

In the second example embodiment of the present disclosure, the learning apparatus 400 will be described which is an information processing apparatus that performs machine learning using a time-series data set. FIG. 12 shows an example of a hardware configuration of the learning apparatus 400. Referring to FIG. 12, the learning apparatus 400 includes, as an example, the following hardware configuration including:
a CPU (Central Processing Unit) 401 (arithmetic logic unit);
a ROM (Read Only Memory) 402 (memory unit);
a RAM (Random Access Memory) 403 (memory unit);
programs 404 loaded into the RAM 403;
a storage device 405 storing the programs 404;
a drive device 406 that performs reading from and writing into a recording medium 410 external to the information processing apparatus;
a communication interface 407 connected to a communication network 411 external to the information processing apparatus;
an input/output interface 408 that performs input/output of data; and
a bus 409 connecting the components.

Further, the learning apparatus 400 can realize functions as an extracting unit 421, a detecting unit 422, an adjusting unit 423, and a storing unit 424 shown in FIG. 13 by the CPU 401 acquiring the programs 404 and executing the programs 404. The programs 404 are, for example, stored in advance in the storage device 405 or the ROM 402, and are loaded into the RAM 403 or the like and executed by the CPU 401 as necessary. Moreover, the programs 404 may be provided to the CPU 401 via the communication network 411, or the programs may be stored in advance in the recording medium 410 and read out by the drive device 406 and provided to the CPU 401.

FIG. 12 shows an example of the hardware configuration of the learning apparatus 400. The hardware configuration of the learning apparatus 400 is not limited to the abovementioned case. For example, the learning apparatus 400 may be configured with part of the abovementioned configuration, such as not having the drive device 406. Further, the CPU 401 may be a GPU or the like illustrated in the first example embodiment.

The extracting unit 421 extracts a feature value from a time-series data set including time-series data on a predetermined observation item by using a trained model.

The detecting unit 422 detects a change in input dimension, which is a change in the number of observation items included in the time-series data set. For example, the detecting unit 422 may detect a change in input dimension according to the number of time-series data included in the time-series data set.

The adjusting unit 423 adjusts at least one of a weight dimension of the model used by the extracting unit 421 in extracting the feature value from the time-series data set or a corresponding input value in accordance with the result of detection by the detecting unit 422. Moreover, the adjusting unit 423 may perform the above adjustment using information indicating the content of a past adjustment stored in the storing unit 424.

The storing unit 424 stores information corresponding to the content of the adjustment by the adjusting unit 423 into the storage device. For example, the storing unit 424 may store information indicating the corresponding observation item and information corresponding to the content of the adjustment, and the like into the storage device.

The above is an example configuration of the learning apparatus 400. Subsequently, an example of operation of the learning apparatus 400 when the input dimension changes will be described with reference to FIG. 14.

FIG. 14 is a flowchart showing an example of operation of the learning apparatus 400. Referring to FIG. 14, the detecting unit 422 detects a change in the input dimension, which is a change in an observation item included in the time-series data set (step S301). The detecting unit 422 may use any means to detect a change in the input dimension.

The adjusting unit 423 adjusts the weight dimension of the model in accordance with the result of detection by the detecting unit 422 (step S302).

The storing unit 424 stores information corresponding to the content of the adjustment by the adjusting unit 423 into the storage device.

The above is an example of operation of the learning apparatus 400 when the input dimension changes.

Thus, the learning apparatus 400 includes the detecting unit 422 and the adjusting unit 423. According to such a configuration, the adjusting unit 423 can perform a predetermined adjustment such as an adjustment of the weight dimension of a model in accordance with the result of detection by the detecting unit 422. As a result, the learning apparatus 400 can respond to a change in the input dimension while continuing to use a common part by performing an adjustment corresponding to the change in the input dimension.

Further, by referring to information stored by the storing unit 424, the learning apparatus 400 can perform an adjustment using past information when it is determined that an observation item deleted in the past has been restored. As a result, the learning apparatus 400 can perform a more efficient adjustment using a past learning result.

The learning apparatus 400 described above can be realized by incorporating a predetermined program into the information processing apparatus such as the learning apparatus 400. To be specific, a program as another aspect of the present invention is a program for causing an information processing apparatus such as the learning apparatus 400 to execute processes to: extract a feature value from a time-series data set including time-series data on a predetermined observation item by using a machine-learned model; detect a change in an input dimension, which is a change in a number of observation items included in the time-series data set; adjust at least one of a weight dimension or a corresponding input value of the model used when extracting the feature value from the time-series data set in accordance with a result of the detection; and store information corresponding to a content of the adjustment into a storage device.

Further, a learning method executed by an information processing apparatus such as the learning apparatus 400 described above is a method by the information processing apparatus including: extracting a feature value from a time-series data set including time-series data on a predetermined observation item by using a machine-learned model; detecting a change in an input dimension, which is a change in a number of observation items included in the time-series data set; adjusting at least one of a weight dimension or a corresponding input value of the model used when extracting the feature value from the time-series data set in accordance with the result of the detection; and storing information corresponding to the content of the adjustment into a storage device.

Even if the invention of a program, or a computer-readable recording medium with a program recorded, or a learning method has the above configuration, the purpose of the present disclosure described above can be achieved because the same action and effect as the learning apparatus 400 described above are achieved.

### SUPPLEMENTARY NOTES

The whole or part of the example embodiments disclosed above can be described as the following supplementary notes. Hereinafter, the overview of the learning apparatus and so forth in the present invention will be described. However, the present invention is not limited to the following configurations.

### Supplementary Note 1

A learning apparatus comprising:
an extracting unit that extracts a feature value from a time-series data set including time-series data on a predetermined observation item by using a machine-learned model;
a detecting unit that detects a change in an input dimension, which is a change in a number of the observation item included by the time-series data set;
an adjusting unit that adjusts at least one of a weight dimension of the model used when the extracting unit extracts the feature value from the time-series data set and a corresponding input value, in accordance with a result of the detection by the detecting unit; and
a storing unit that stores information corresponding to a content of the adjustment by the adjusting unit into a storage device.

### Supplementary Note 2

The learning apparatus according to supplementary note 1, wherein
when the adjusting unit performs a predetermined adjustment in accordance with detection of input dimension reduction by the detecting unit, the storing unit stores information corresponding to a content of the adjustment into the storage device.

### Supplementary Note 3

The learning apparatus according to supplementary note 2, wherein
the adjusting unit refers to the information stored by the storing unit in accordance with detection of input dimension increase by the detecting unit, and thereby confirm whether or not an increased observation item is one having been deleted previously.

### Supplementary Note 4

The learning apparatus according to supplementary note 3, wherein
in a case where the increased observation item is one having been deleted previously, the adjusting unit adjusts at least one of the weight dimension of the model and the corresponding input value by using the information stored by the storing unit.

### Supplementary Note 5

The learning apparatus according to supplementary note 3 or 4, wherein
in a case where the increased observation item is not one having been deleted previously, the adjusting unit expands the weight dimension of the model in accordance with the detection of input dimension increase by the detecting unit.

### Supplementary Note 6

The learning apparatus according to any of supplementary notes 1 to 5, wherein
the adjusting unit reduces the weight dimension of the model or adjusts the corresponding input value to zero in accordance with detection of input dimension reduction by the detecting unit.

### Supplementary Note 7

The learning apparatus according to any of supplementary notes 1 to 6, wherein
the detecting unit detects a change in a number of a sensor acquiring the time-series data as the change in the input dimension.

### Supplementary Note 8

The learning apparatus according to any of supplementary notes 1 to 7, comprising:
a learning unit that performs machine learning of updating the weight of the model by using the extracted feature value extracted by the extracting unit;
a transforming unit that transforms the feature value extracted by the extracting unit into a binary code;
a storage unit that stores the binary code obtained by the transformation by the transforming unit; and
a retrieval unit that retrieves the binary code stored by the storing unit by using a binary code obtained by transforming a time-series data set to be a retrieval target.

### Supplementary Note 9

A learning method by an information processing apparatus, the learning method comprising:
extracting a feature value from a time-series data set including time-series data on a predetermined observation item by using a machine-learned model;
detecting a change in an input dimension, which is a change in a number of the observation item included by the time-series data set;
adjusting at least one of a weight dimension of the model used in extracting the feature value from the time-series data set and a corresponding input value in accordance with a result of the detection; and
storing information corresponding to a content of the adjustment into a storage device.

### Supplementary Note 10

A program comprising instructions for causing an information processing apparatus to:
extract a feature value from a time-series data set including time-series data on a predetermined observation item by using a machine-learned model;
detect a change in an input dimension, which is a change in a number of the observation items included by the time-series data set;
adjust at least one of a weight dimension of the model used in extracting the feature value from the time-series data set and a corresponding input value in accordance with a result of the detection; and
store information corresponding to a content of the adjustment into a storage device.

All or some of the configurations described in Supplementary Notes 2 to 8 dependent on the learning apparatus described in Supplementary Note 1 may be dependent on the learning method described in Supplementary Note 9 and the program described in Supplementary Note 10 by the same dependence. Furthermore, not limited to Supplementary Notes 9 and 10, within the scope of the respective example embodiments described above, some or all of the configurations described as supplementary notes may be dependent on various hardware, software, various recording means for recording software, or systems.

The programs described in the above example embodiments and supplementary notes may be stored in a storage device, or the programs may be recorded in a computer-readable recording medium. For example, the recording medium is a portable medium such as flexible disk, optical disk, magneto-optical disk, and semiconductor memory.

Although the present invention has been described above with reference to the above example embodiments, the present invention is not limited to the example embodiments described above. The configuration and details of the present invention can be changed in various manners that can be understood by those skilled in the art within the scope of the present invention.

### DESCRIPTION OF REFERENCE NUMERALS

100 learning apparatus
110 operation input unit
120 screen display unit
130 communication interface unit
140 storing unit
141 model information
142 feature value information
143 time-series data information
144 observation item information
145 program
150 arithmetic processing unit
151 time-series data acquiring unit
152 feature value extracting unit
153 binary code transforming unit
154 model training unit
155 input dimension change detecting unit
156 adjusting unit
157 observation item information storing unit
158 retrieve unit
159 output unit
200 optical network
300 biosensor
400 learning apparatus
401 CPU
402 ROM
403 RAM
404 programs
405 storage device
406 drive device
407 communication interface
408 input/output interface
409 bus
410 recording medium
411 communication network
421 extracting unit
422 detecting unit
423 adjusting unit
424 storing unit

1. A learning apparatus comprising:
at least one memory storing processing instructions; and
at least one processor configured to execute the processing instructions, wherein the at least one processor is configured to execute the processing instructions to:
extract a feature value from a time-series data set including time-series data on a predetermined observation item by using a machine-learned model;
detect a change in an input dimension, which is a change in a number of the observation item included by the time-series data set;
adjust at least one of a weight dimension of the model used when extracting the feature value from the time-series data set and a corresponding input value, in accordance with a result of the detection; and
store information corresponding to a content of the adjustment into a storage device.

2. The learning apparatus according to claim 1, wherein the at least one processor is configured to execute the processing instructions to
when performing a predetermined adjustment in accordance with detection of input dimension reduction, store information corresponding to a content of the adjustment into the storage device.

3. The learning apparatus according to claim 2, wherein the at least one processor is configured to execute the processing instructions to
when performing the adjustment, refer to the stored information in accordance with detection of input dimension increase, and thereby confirm whether or not an increased observation item is one having been deleted previously.

4. The learning apparatus according to claim 3, wherein the at least one processor is configured to execute the processing instructions to
in a case where the increased observation item is one having been deleted previously, adjust at least one of the weight dimension of the model and the corresponding input value by using the information stored in the storage device.

5. The learning apparatus according to claim 3, wherein the at least one processor is configured to execute the processing instructions to
in a case where the increased observation item is not one having been deleted previously, expand the weight dimension of the model in accordance with the detection of input dimension increase.

6. The learning apparatus according to claim 1, wherein the at least one processor is configured to execute the processing instructions to
reduce the weight dimension of the model or adjust the corresponding input value to zero in accordance with detection of input dimension reduction.

7. The learning apparatus according to claim 1, wherein the at least one processor is configured to execute the processing instructions to
detect a change in a number of a sensor acquiring the time-series data as the change in the input dimension.

8. The learning apparatus according to claim 1, wherein the at least one processor is configured to execute the processing instructions to:
perform machine learning of updating the weight of the model by using the extracted feature value;
transform the extracted feature value into a binary code;
store the binary code obtained by the transformation; and
retrieve the stored binary code by using a binary code obtained by transforming a time-series data set to be a retrieval target.

9. A learning method by an information processing apparatus, the learning method comprising:
extracting a feature value from a time-series data set including time-series data on a predetermined observation item by using a machine-learned model;
detecting a change in an input dimension, which is a change in a number of the observation item included by the time-series data set;
adjusting at least one of a weight dimension of the model used when extracting the feature value from the time-series data set and a corresponding input value in accordance with a result of the detection; and
storing information corresponding to a content of the adjustment into a storage device.

10. A non-transitory computer-readable recording medium with a program recorded thereon, the program comprising instructions for causing an information processing apparatus to:
extract a feature value from a time-series data set including time-series data on a predetermined observation item by using a machine-learned model;
detect a change in an input dimension, which is a change in a number of the observation items included by the time-series data set;
adjust at least one of a weight dimension of the model used when extracting the feature value from the time-series data set and a corresponding input value in accordance with a result of the detection; and
store information corresponding to a content of the adjustment into a storage device.
